(19) United States
(12) Patent Application Publication
(10) Pub. No.: US 2008/0241476 A1
(43) Pub. Date: Oct. 2, 2008

(54) ASYMMETRIC ELASTIC FILM NONWOVEN LAMINATE

(75) Inventor: SAUL BRIONES OLGUIN, San Luis Potosi (MX)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/693,785

(22) Filed: Mar. 30, 2007

(51) Int. Cl. B32B 25/10

(52) U.S. Cl. 428/152; 442/399

(57) ABSTRACT

An elastic nonwoven laminate comprising an elastic film layer extrusion laminated along at least one face to an asymmetric nonwoven web. The elastic film layer is extrusion laminated along a plurality of cross direction extending bond lines were the asymmetric nonwoven fibers are at least partially embedded into the extruded elastic film. The asymmetric nonwoven webs are preferably bonded to both faces of the elastic film layer where the bond lines are 0.1 to 2.0 mm wide and there are from 0.5 to 10 bond lines/cm.

### TECHNICAL FIELD

The present invention relates to cross directional stretchable elastic film nonwoven laminates comprising an extruded thermoplastic elastic film extrusion bonded on one or both sides to an asymmetric nonwoven material and to methods and equipment for making such elastic nonwoven laminates and products such as disposable garments (including diapers, training pants, and adult incompetence briefs) in which they are used.

### BACKGROUND OF THE INVENTION

Elastic nonwoven laminates are highly desirable for use in the field of disposable absorbent article such as diapers, adult incontinent products, feminine hygiene and the like. Elastic films are difficult to handle and have undesirable tactile and strength properties. For these reasons and others the art has proposed laminating nonwovens to elastic films. The nonwovens strengthen the elastic film and provide a soft and non-tacky feel. The problem is that with attached nonwovens the nonwoven elastic film laminate is often a product with little or no elastic properties. Numerous patents have addressed this problem. Many solutions are directed at ways to “activate” the elastic nonwoven laminate, which generally involves weakening the nonwoven in the direction of desired elasticity, generally by stretching. Namely an elastic nonwoven laminate is formed and then placed under tension by a variety of techniques and stretched, see e.g., U.S. Pat. Nos. 5,167,887; 4,834,741 and 7,039,990. The stretching weakens the attached nonwoven allowing the underlying elastic to more freely stretch and recover. One problem with this approach is that to difficult to obtain uniform stretching of the entire laminate at low elongations which can be addressed by stretching the laminate to the natural draw ratio of the elastic film. However, if the laminate is stretched to the natural draw ratio of the elastic film to obtain uniform stretching the elastic properties may not be those desired and/or the laminate could break.

Another proposed method to obtain cross-direction elastic properties, discussed in U.S. Pat. No. 5,789,065, is by using nonwoven type fabrics that are necked prior to applying them to an elastic sheet. This is stretching of a nonwoven fabric or other fabrics prior to lamination to an elastic film or the like. Necking is the process of reducing the width of a nonwoven, or the like, by stretching the nonwoven lengthwise. Not all nonwovens are neckable so care needs to be made in selecting the nonwoven. The resulting necked nonwoven is subsequently easily stretched in the width or cross direction at least up to the original dimensions of the necked nonwoven. The necking process typically involves unwinding a sheet from a supply roll and passing it through a brake nip roll assembly driven at a given linear speed. A takeup roll, operating at a linear speed higher than the brake nip roll, draws the fabric and generates tension in the fabric needed to elongate and neck, as disclosed for example in U.S. Pat. Nos. 4,965,122 and 5,789,065, which later patent describes a problem with necking being uneven properties of the necked material with the edges of the nonwoven material necking to the greatest degree and the central area necking the least, which causes a difference in properties of the resulting elastic nonwoven laminate at the edges versus the center of the elastic laminate.

For elastic laminate products such as the necked nonwoven laminates, as described in U.S. Pat. No. 5,789,065, it is taught that for extrusion laminated products it is important that when joining the elastic extrudate to the nonwoven in a nip roll that the nip roll has a gap during laminate formation. It is stated that if the nip roll gap is too large, there will be insufficient pressure applied to the layers and adhesion of the nonwoven webs will be inadequate, producing a laminate that will have poor peel characteristics (will tend to delaminate). If the gap is too small or the nip is closed, the resulting laminate will be stiff as the thermoplastic elastomer penetrates farther into the nonwoven web fabric, reducing fiber flexibility and mobility, which results in a laminate product with low elasticity even when activated, or a product that is difficult to activate. U.S. Pat. No. 5,789,065, contrary to this practice, proposes extrusion laminating a thermoplastic elastomeric film between two sheets of nonwoven using a closed nip, followed by necking the laminate while it is at an elevated temperature. This heating presumably allows the fibers to move and the laminate to stretch. As the elastic laminate is heated and stretched the elastic film loses its memory and does not recover, however the attached nonwoven is “necked”, presumably more evenly than if necked prior to being attached to the elastic film. The elastic film when cooled is “reset” in the necked condition and the laminate is stretchable in the cross direction.

U.S. Pat. No. 5,804,021 discloses an alternative method of weakening the nonwoven by providing it with slits that extend in the machine or cross direction. Machine direction slits will provide an elastic laminate with cross direction elasticity and cross direction slits will provide an elastic laminate with machine direction elasticity, i.e. the elastic properties are perpendicular to the direction of the slits. This nonwoven weakened by slitting would make the material difficult to handle if done prior to lamination and there is no method disclosed as to how to slit a nonwoven layer after lamination.

### SUMMARY OF THE INVENTION

The invention elastic nonwoven laminate comprises an elastic film layer extrusion laminated along at least one face to an asymmetric nonwoven web. The elastic film layer is extrusion laminated along a plurality of cross direction extending bond lines were the asymmetric nonwoven fibers are at least partially embedded into the extruded elastic film. The asymmetric nonwoven webs are preferably bonded to both faces of the elastic film layer where the bond lines are 0.1 to 2.0 mm wide and there are from 0.5 to 10 bond lines/cm.

These and other features and advantages of the products and methods of the present invention will be described with respect to illustrative embodiments of the invention set forth in the following drawings, detailed description, and claims.

### BRIEF DESCRIPTION OF THE DRAWINGS

FIG. 1 is a schematic view of a first embodiment method for forming the invention elastic nonwoven laminate

FIG. 2 is a schematic view of a second embodiment method for forming the invention elastic nonwoven laminate

### DETAILED DESCRIPTION OF THE INVENTION

As used herein the term “nonwoven fabric or web” means a web having a structure of individual fibers or threads which are interlaid, but not in an identifiable manner as in a woven fabric. Nonwoven fabrics or webs can be formed by many processes such as for example, meltblowing processes, spunbond processes, and carded-web processes. An “asymmetric nonwoven fabric or web” is one where the ratio of the machine direction tensile strength to cross directional tensile strength of the nonwoven is at least 4 or 5 and generally from 4 to 20

As used herein the term “unbonded nonwoven fabric or web” is a nonwoven web that has no external bonding applied to it, such as by calendaring or point bonding, but would include webs that are autogenously bonded or entangled to some extend during the web formation process. For example meltblown web fibers are generally somewhat tacky when they intersect each other the first time which results in some level of fiber-to-fiber autogenous bonding, as a result a meltblown web typically does not require external bonding but is externally bonded for some applications. Spunbond web fibers are drawn such that they do not immediately intersect as they exit the die orifices and as such are usually tack free by the time they first intersect each other and generally do not form autogenous bonds, Spunbond webs usually require some external bonding technique to make them handleable. Carded webs are formed of fibers that are mechanically entangled with each other but are discontinuous fibers that would require some degree of external bonding to make the web handleable or stable.

As used herein the term “elastic film ” refers to an elastic film material which may be a single layer film, a multicomponent elastic film material or a multilayer film material, which may be of constant or variable thickness. The elastic film as made is substantially continuous at least in the cross direction but could later be slit or punched or the like. Suitable elastic films and processes for their production are disclosed, for example, in U.S. Pat. Nos. 5,691,034, 5,429,856 and 5,344,691.

As used herein the term “spunbond or spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,502,538 to Levy, and U.S. Pat. No. 3,542,615 to Dobo et al. Spunbond fibers are generally not tacky when they are deposited onto a collecting surface and require further bonding to make them coherent. Spunbond fibers are generally continuous and have average diameter larger than about 7 microns, more particularly, between about 5 and 40 microns. Directionality can be imparted to the web by directing the spunbond fibers onto an angled collection surface or using a directional air stream at or near the collection surface.

As used herein the term “meltblown fibers” means fibers formed by extruding a molten thermoplastic material through a plurality of fine, usually circular, die capillaries as molten threads or filaments into converging high velocity gas (e.g. air) streams which attenuate the filaments of molten thermoplastic material to reduce their diameter and entangle the fibers. Thereafter, the meltblown fibers are carried by the high velocity gas stream and are deposited on a collecting surface to form an entangled web of randomly disbursed meltblown fibers. Directionality can be imparted to the web by directing the meltblown fibers onto an angled collection surface or using a directional air stream at or near the collection surface. The meltblown fibers generally bond to each other prior to collection and a meltblown web is generally coherent without additional external bonding. Meltblown fibers may be continuous and/or discontinuous, and generally are smaller than about 100 microns on average diameter.

As used herein “carded web” means a nonwoven web formed by a mechanical process whereby clumps of staple fibers are separated into individual fibers and simultaneously made into a coherent web. The operation is generally carried out on a machine which utilizes opposed moving beds of fine, angled closely spaced needles or their equivalent to pull and tease the clumps apart. Typically, opposing moving beds of needles are wrapped on a large main cylinder and a large number of narrow flats, also referred to as the “scrambler rolls,” are held on an endless belt that is placed over the top of the main cylinder. The needles of the two opposing surfaces are inclined in opposite directions and move at different speeds relative to each other. The main cylinder moves at a higher surface speed than the flats. The clumps between the two beds of needles are separated into fibers and are aligned in the machine direction as each fiber is theoretically held at each end by individual needles from the two beds. The individualized fibers engage each other randomly, and with the help of their crimp, form a coherent web at and below the surface of the needles on the main cylinder. The carding machine includes a mechanism for adjusting the speed of the rolls relative to one another. In manufacturing nonwoven carded webs or fabrics, it is typically desirable that the fibers are laid down randomly to form the carded web and are not highly oriented. Accordingly, the carding machine is typically adjusted so that the scrambler rolls provide a high scramble ratio, i.e., a large number of fibers having a transverse orientation to the machine direction of the fabric. The degree of scramble, or transverse orientation, can be expressed as a ratio of tensile strength of the fabric in the machine direction (MD) as compared to the tensile strength in the cross-machine direction (CD) of the carded web (expressed as MD/CD grams/inch). Carding machines for nonwovens can be adjusted to provide a scramble ratio of, for example, about 2/1 to about 10/1. Higher ratios may be achieved, i.e., up to about 20:1.

In contrast to typical nonwoven carding procedures, in the present invention, the carded web is formed so that the fibers are highly oriented in the machine direction, i.e., so that the number of fibers laid down transverse to the machine direction are controlled. The degree of orientation of the fibers of the carded webs used in accordance with the present invention can be expressed as a function of the ratio of the tensile strength of the carded web in the machine direction to that in the cross-machine direction. Preferably the carded webs used in accordance with the invention have a tensile strength ratio of at least about 4/1 and preferably at least about 6/1 after bonding of the carded web or joining the carded web to the elastic film layer.

As used herein the term “polymer” generally includes, but is not limited to, homopolymers, copolymers, such as for example, block, graft, random and alternating copolymers, terpolymers, etc., and blends and modifications thereof. Furthermore, unless otherwise specifically limited, the term “polymer” shall include all possible geometrical molecular configuration of the material. These configurations include, but are not limited to isotactic, syndiotactic and atactic symmetries.

As used herein, the term “metallocene” means polyolefins produced by metallocene-catalyzed polymerization reactions. Such catalysts are reported in “Metallocene Catalysts Initiate New Era in Polymer Synthesis,” Ann M. Thayer, C &EN, Sep. 11, 1995, p. 15.

As used herein, the term “machine direction” or “MD” means the length of a fabric in the direction in which it is produced. The term “cross machine direction” or “CD” means the width of fabric, i.e., a direction generally perpendicular to the MD.

As used herein, the terms “elastic” and “elastomeric” when referring to film layer or laminate mean a material which upon application of a biasing force, is stretchable to a stretched, biased length which is at least about 50 percent greater than its relaxed, unstretched length, and which will recover at least 40-60 percent of its elongation upon release of the stretching, biasing force within about one minute.

As used herein the term “protective apparel” means articles including, but not limited to, surgical gowns, isolation gowns, coveralls, lab coats and the like.

As used herein the term “personal care absorbent products” means articles including, but not limited to, diapers, adult incontinence products, feminine hygiene products and garments, and child care training pants.

The present invention comprises a laminated elastic film and nonwoven web fabric having desirable cross direction (CD) elasticity and machine direction strength. In general, at least one, and preferably two, asymmetric nonwoven web materials are extrusion laminated to one, or both, faces of an elastic film material, and then optionally stretched in the CD direction by at least 50 percent or at least 75 percent. The asymmetric nonwoven web materials are extrusion laminated and bonded to the elastic film material along one or more linear bond lines that extend in the CD direction. The bond lines are generally straight and extend primarily in the CD direction, but some or all of the bond lines can be curved or angled so that they extend in the MD direction to some extent. The bond lines are generally from are 0.1 to 2.0 mm wide or 0.5 to 1.5 mm wide and there are from 0.5 to 10 bond lines/cm or from 1 to 5 bond lines/cm. The bond lines are generally continuous in the CD direction of the laminate but could be discontinuous as will be discuss below. The asymmetric nonwoven will be autogenously bonded to the extruded elastic film such that at least some of the fibers of the nonwoven penetrate or are embedded into the extruded elastic film along the bond lines. Between the bond lines the asymmetric nonwoven is preferably not autogenously bonded to the extruded elastic film by any fibers embedding into the extruded elastic film.

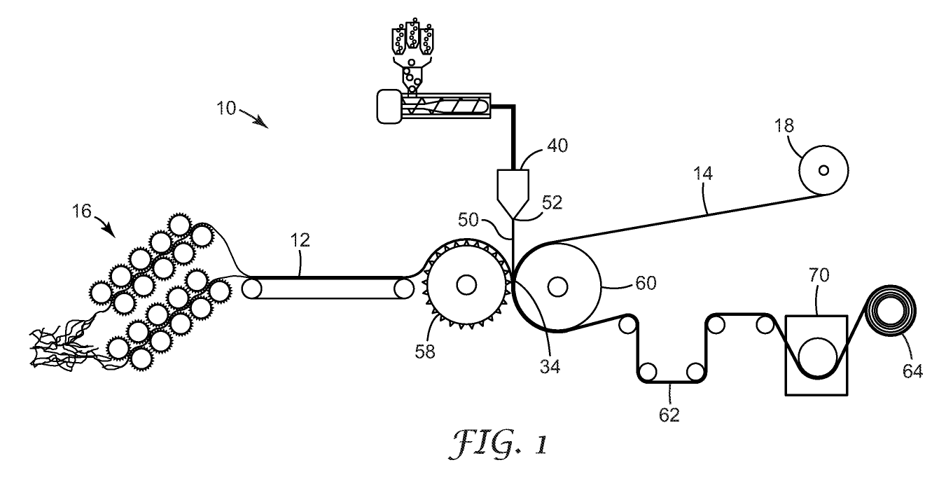

FIG. 1 shows an apparatus 10 for continuously forming the laminate of the present invention, a first sheet of asymmetric nonwoven material 12 and a second sheet of asymmetric nonwoven material 14, preferably provided on a continuous supply roll or directly from a web forming station. The asymmetric nonwoven webs 12 and 14 can be formed by any of a number of processes well known in the art. Such processes include, but are not limited to, carding, spunbond, meltblowing, and the like. Carding is preferred for producing at least one asymmetric nonwoven material 12 directly prior to the extrusion bonding nip point 34. The carded asymmetric nonwoven web is preferably not externally bonded except in the extrusion bonding process to the extruded elastic film. The nonwoven webs may be formed by the same or different processes and made of the same or different starting materials. The asymmetric nonwoven materials will usually have a basis weight of from about 10 g/m² to about 50 g/m² or more particularly from about 10 g/m² to about 20 g/m² A particular preferred embodiment uses an unbonded asymmetric carded fabric for the first nonwoven webs 12 and an asymmetric bonded carded nonwoven material as the second sheet 14. It is to be understood that the present invention can be practiced using a single sheet of asymmetric nonwoven material extrusion laminated to the elastic film material.

Elastomeric thermoplastic polymers useful in the practice of this invention as the elastic film layer may be, but are not limited to, those made from block copolymers such as polyurethanes, copolyether esters, polyamide polyether block copolymers, ethylene vinyl acetates (EVA), vinyl arene (e.g. styrenic) containing block copolymers having the general formula A-B-A′ or A-B such as copoly(styrene/ethylene-butylene), polystyrene-poly(ethylene-propylene) polystyrene, polystyrene-poly(ethylene-butylene)-polystyrene, (polystyrene/poly(ethylene-butylene)/polystyrene, poly(styrene/ethylene-butylene/polystyrene), metallocene-catalyzed polyolefins or copolymers thereof such as ethylene-(propylene, butene, hexene or octene), wherein such materials generally have a density of about 0.866-0.910 g/cc.

Useful elastomeric resins include, but are not limited to, block copolymers having the general formula A-B-A′ or A-B, where A and A′ are each a thermoplastic polymer endblock which contains a vinyl arene moity such as a poly(vinyl arene), which is typically styrene, and where B is an elastomeric polymer midblock such as a conjugated diene or a lower alkene polymer. Block copolymers of the A-B-A′ type can have different or the same thermoplastic block polymers for the A and A′ blocks, and the present block copolymers are intended to embrace linear, branched and radial block copolymers. In this regard, the radial block copolymers may be designated (A-B)m-X, wherein X is a polyfunctional atom or molecule and in which each (A-B)m-radiates from X in a way that A is an endblock. In the radial block copolymer, X may be an organic or inorganic polyfunctional atom or molecule and m is an integer having the same value as the functional group originally present in X. It is usually at least 3, and is frequently 4 or 5, but not limited thereto. Thus, in the present invention, the expression “block copolymer”, and particularly A-B-A′ and A-B block copolymer, is intended to embrace all block copolymers having such rubbery blocks and thermoplastic blocks as discussed above, which can be extruded and without limitation as to the number of blocks. A-B-A-B tetrablock copolymer are also considered block copolymers are discussed above may also be used in the practice of this invention as the elastic film layer.

Elastomeric polymers also include copolymers of ethylene and at least one vinyl monomer such as, for example, vinyl acetates, unsaturated aliphatic monocarboxylic acids, and esters of such monocarboxylic acids. The elastomeric copolymers and formation of elastomeric nonwoven webs from those elastomeric copolymers are disclosed in, for example, U.S. Pat. No. 4,803,117.

In a preferred embodiment the asymmetric nonwoven material has fibers oriented in mostly in the MD direction. Such nonwoven webs can be formed by any of a number of processes or techniques well known to those of ordinary skill in the art and described briefly above. Preferred are bonded carded webs and unbonded carded webs. The result of such processes is that the fiber orientation is at a low average angle or vector with respect to the machine direction of the sheet. Preferably, the fiber orientation vector in the asymmetric nonwoven material (from the machine direction of the sheet) is from about 0° to about 30 degrees, more preferably from about 0 to 20 degrees. The asymmetric nonwoven material generally has a CD tensile strength at break of less than 750 grams force per 50 mm or less than 600 grams force per 50 mm. The asymmetric nonwoven material generally has a MD tensile strength at break of at least 1000 grams force per 50 mm or at least 2000 grams force per 50 mm. The asymmetric nonwoven material should also generally have an elongation at break of at least 50 percent in either direction (CD or MD).

In the specific embodiment illustrated in FIG. 1 the first asymmetric nonwoven web 12 is fed directly from a carded web forming station 16 and a second preformed bonded carded asymmetric nonwoven web 14 is unwound from the supply roll 18. The asymmetric nonwoven webs 12 and 14 are configured to advance in an intersecting relationship to a nip contact zone 34 located beneath an extrusion station 40.

A sheet 50 of elastic film material is extruded as an elastomeric thermoplastic polymer through a die lip 52. The basis weight of the elastomeric film is generally from 30 to 100 g/m² or 40 to 80 g/m². The elastic film 50 may also be a multilayer film material. Additionally, the film 50 may be a multilayer film material in which one or more of the layers are an inelastic film layer. An example of the latter type of elastic web, reference is made to U.S. Pat. No. 5,691,034.

The extruded elastic film 50 is deposited into the nip contact zone 34 so that the asymmetric nonwoven webs 12 and 14 immediately sandwich the extruded film 50. The extruded film is still soft such that certain of the fibers forming the asymmetric nonwoven webs can at least partially penetrate into the matrix of the film layer forming a autogenous bond, which is also termed embedding herein. In the nip contact zone 34 the nip generally has a gap between the two opposing rolls 58 and 60 of from 2 to 10 mils (50 to 250 microns), or from 4 to 8 mils (100 to 200 microns). The gap however will depend on the thickness and/or basis weight of the extruded film and the asymmetric nonwoven webs. The gap should be sufficient to ensure that some fibers of the asymmetric nonwoven web are embedded into the film layer but not to a degree such that the laminate becomes boardy or stiff. The resulting laminate should have an initial extension in the CD direction of at least 10 percent at 2.5 Kg force per 50 mm or at least 30 percent at 2.5 Kg force per 50 mm. The elongation in the MD direction at 2.5 Kg force per 50 mm should generally be less than 10 percent or less than 5 percent.

The asymmetric nonwoven webs 12, 14 and the extruded film 50 are introduced into the nip contact zone 34 formed by a first pressure roll 58 and a second pressure roll 60, which are set to define the above controlled gap between the rolls. At least one of the rolls 58 or 60 has a series of raised ridges forming the cross directional one or more bond lines, while the opposing roll is preferably smooth or at least contacts the bond line forming ridges of the opposing pressure roll. The ridges corresponding to the bond lines and have corresponding widths and spacings. The ridges and resulting bond lines are generally continuous across the width of the laminate however one or more of the ridges could be intermittent. If one or more of the ridges is intermittent, and where one or both of the asymmetric nonwoven webs is an unbonded carded web, or the like, it is preferred that one or more of the ridges adjacent the intermittent ridge extend across the cross directional areas where an intermittent ridge is not present to avoid there being unbonded extents of the laminate in the machine direction that are longer than the average fiber length of the fibers forming the carded web. Desirably, one or both of the rolls 58 and 60 may be chilled.

The resulting elastic laminate has an extruded film of elastic thermoplastic material, and at least one autogenously bonded or attached asymmetric nonwoven web that has CD extending bond lines that are longitudinally spaced apart in the MD direction of the laminate. The elastic film is morphologically substantially the same at the bond lines as between the bond lines and remains elastic at the bond line locations. The laminate material 62 can be wound onto a supply roll 64 for storage. Alternatively, the material 62 can be moved directly to a cross web stretching assembly 70.

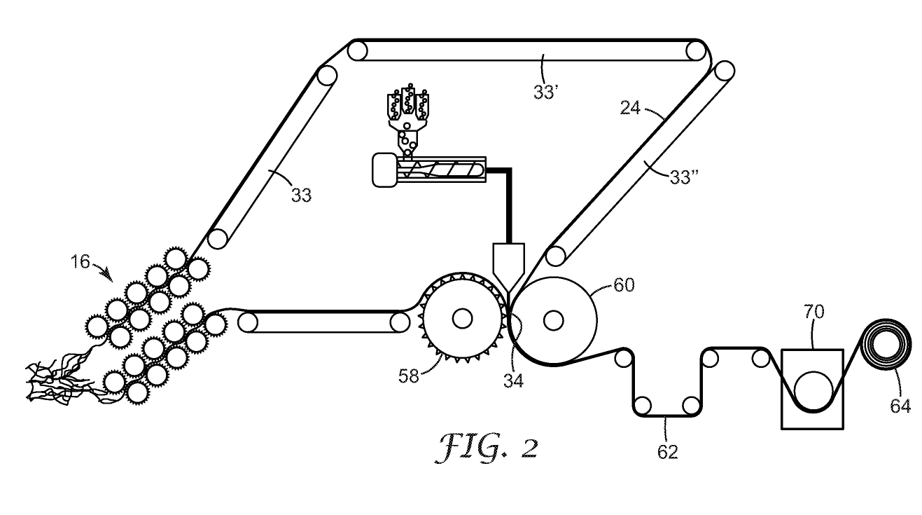

FIG. 2 is an alternative embodiment of the process described with respect to FIG. 1. All the same features are identically numbered and the description of their function will not be repeated. In FIG. 2 instead of one unbonded carded web being used, two separate unbonded carded webs are fed from the carding unit 16 to opposite sides of the extruded elastic film in the nip contact zone 34. The second unbonded carded web 24 is carried by conveyors 33, 33′ 33″ to the nip side adjacent the smooth roll 60 as shown.

A surprising result of the present invention is the resulting elastic laminate product formed has very good CD elastic properties and high MD strength by only using cross direction bond lines. The resulting elastic laminate is a cross direction extensible elastic film laminate that is capable of uniform extension in the cross direction at relatively low elongations and which can be used without the need to mechanically “activate ” the laminate for it to become elastic. Although activation can be used the laminate is such that activation is easily doable by a consumer at a relatively low force level. Also as only CD bond lines are used, the asymmetric nonwoven web is lofty between the bond lines resulting in an elastic nonwoven laminate that has very good tactile properties and flexibility.

The present invention elastic laminate can be used in personal care absorbent products as side tabs or ears on diapers, child care training pants, and the like which need to be strong and elastic, yet resistant to peeling. It is possible to construct entire products using the elastic laminate material of the present invention. Another use of the elastic laminate of the present invention is as the side pieces in adult incontinence products and feminine care pants, where elasticity is important. Additionally, the present invention elastic laminate can be incorporated into protective apparel.

This invention may be illustrated by way of the following example.

### EXAMPLE OF THE INVENTION

A cross directional stretchable elastic laminate 62 according to the present invention was made using the method illustrated in and described with respect to the FIG. 1. Cut 4 denier polypropylene fibers 4.76 centimeters (1.875 inches) long obtained under the commercial designations “4.0 Denier T-196, Merge 840-060-1702” from FiberVisions™, Covington, Ga., were formed, using the carding machine 16, into a continuous web of fibers 12 having a basis weight of 35 grams per square meter with the majority of the fibers oriented in the machine direction (i.e. 90 percent).

A blend of a 98 weight percent of an olefinic based specialty elastomer commercially designated “Vistamaxx VM-1100” commercially available from the ExxonMobil Chemical Company, Houston, Tex., and a 2 weight percent of a white color master batch commercially designated “P White 1015100S” from Clariant Masterbatches, Minneapolis, Minn., was fed into a single screw extruder in order to obtain a homogenous melt state blend, the melt state blend was extruded through the die lip 52 at a die temperature of 464 degrees F. (240 degrees C.) to form a continuous curtain of molten elastic polymer 50 having a basis weight of 60 grams per square meter.

The asymmetric web of fibers 12 (carded web) and the molten elastic polymer 50 were fed into a nip formed by a cross-directional line pressure roller 58 and a second pressure roll 60. An asymmetric nonwoven web 14 obtained under the commercial designation “Hidrophbic Apparel Non Woven 15 gr/m²” commercially available from Maquin S. A. de C. V., Huejotzingo, Puebla (Mexico), with a MD/CD tensile strength ratio between 7 and 10 and with a very low cross-directional tensile strength (i.e. 0.26-0.28 Kg force per 50 mm width, evaluated using an Instron Machine, 2 inches jaw width, 1.18 inches of separation between jaws and 20 in/min jaw speed) was also fed into the nip on the side of the molten elastic polymer on the side opposite the asymmetric carded web 12.

The cross-directional line pressure roll 58 with a temperature between 220 and 238 degrees F. (140 and 150 degrees C.) was used to bond the fibers of the asymmetric web of fibers 12 and at the same time to bond the asymmetric web of fibers 12 with the elastic film 50 and with the asymmetric nonwoven web 14. A 6 mil (0.006 inches or 150 microns) gap was used between the first pressure roll 58 and the second pressure roll 60 which was maintained at a temperature of about minus 14 degrees F. (10 degrees C.). The aforementioned gap, the temperature of the first pressure roll 58, the temperature of the elastic film 50 extruded through the die 52 and the temperature of the second pressure roll 60 were enough to ensure the proper degree of bonding of the resulting elastic laminate.

The cross directional stretchable elastic laminate 62 was evaluated for tensile strength at break point and three cycle hysteresis analysis (conducted at 2500 grams maximum force). Samples were tested in both machine and crossweb direction. An Instron model 5564, with jaw speed of 20 inch/minute, 2 inches jaw width, and 3 centimeter (1.18 inch) of separation between jaws was used for the testing.

Evaluation in the crossweb direction showed that the elastic laminate at break point had a tensile strength of 3.534 Kg force per 50 mm width and had elongated by about 190 percent. At a maximum force of 2.5 Kg per 50 mm width, the material showed a permanent set between 10 and 20 percent and had elongated by about 46 percent (first cycle of the hysteresis analysis).

Evaluation in the machine direction showed that the elastic laminate at break point had a tensile strength of 8.447 Kg force per 50 mm width and had elongated by about 51 percent, for a force of 2.5 Kg per 50 mm width the material had elongated between 3 and 4 percent.

Various modifications and alterations of this invention will become apparent to those skilled in the art without departing from the scope of this invention, and it should be understood that this invention is not to be unduly limited to illustrative embodiments set forth herein, but is to be controlled by the limitations set forth in the claims and any equivalents to those limitations. Further all patents publications mentioned herein are hereby expressly incorporated by reference in there entirety. Other embodiments of the invention are within the scope of the following claims.

1. A cross directionally elastically extensible nonwoven laminate comprising:
an elastic film layer autogenously bonded along at least one face to an asymmetric nonwoven web along a plurality of cross direction extending bond lines where the asymmetric nonwoven fibers are at least partially embedded into the elastic film along the bond lines, the elastic film layer is morphologically substantially the same at the bond lines as between the bond lines and the elastic film layer remains substantially elastic at the bond lines and wherein the asymmetric nonwoven web ratio of machine direction tensile strength to cross direction tensile strength is at least 4.

2. The cross directionally elastically extensible nonwoven laminate of claim 1, wherein there is an asymmetric nonwoven web bonded to both faces of the elastic film layer.

3. The cross directionally elastically extensible nonwoven laminate of claim 2, wherein the bond lines are from 0.1 to 2.0 mm wide and there are from 0.5 to 10 bond lines/cm.

4. The cross directionally elastically extensible nonwoven laminate of claim 3, wherein the bond lines are from 0.5 to 1.5 mm wide and there are from 1 to 5 bond lines/cm.

5. The cross directionally elastically extensible nonwoven laminate of claim 3, wherein the asymmetric nonwoven is substantially unbonded to the elastic film between the bond lines.

6. The cross directionally elastically extensible nonwoven laminate of claim 5, wherein the asymmetric nonwoven has a basis weight of from 10 to about 50 g/m² and wherein the asymmetric nonwoven web ratio of machine direction tensile strength to cross direction tensile strength is from 4 to 20.

7. The cross directionally elastically extensible nonwoven laminate of claim 6, wherein the basis weight of the elastomeric film is from 30 to 100 g/m² and the basis weight of the asymmetric nonwoven is from 10 to 20 g/m².

8. The cross directionally elastically extensible nonwoven laminate of claim 5, wherein the asymmetric nonwoven has a CD tensile force at break of less than 750 grams force per 50 mm.

9. The cross directionally elastically extensible nonwoven laminate of claim 5, wherein the asymmetric nonwoven has a CD tensile force at break of less than 600 grams force per 50 mm.

10. The cross directionally elastically extensible nonwoven laminate of claim 5, wherein the asymmetric nonwoven has a MD tensile force at break of greater than 1000 grams force per 50 mm.

11. The cross directionally elastically extensible nonwoven laminate of claim 5, wherein the asymmetric nonwoven has a MD tensile force at break of greater than 2000 grams force per 50 mm.

12. The cross directionally elastically extensible nonwoven laminate of claim 5, wherein the asymmetric nonwoven is a carded nonwoven.

13. The cross directionally elastically extensible nonwoven laminate of claim 5, wherein the asymmetric nonwoven is an unbonded carded nonwoven.

14. The cross directionally elastically extensible nonwoven laminate of claim 5, wherein the asymmetric nonwoven is a bonded carded nonwoven.

15. The cross directionally elastically extensible nonwoven laminate of claim 1, wherein the bond lines extend continuously across the laminate.
